(19) United States
(12) Patent Application Publication
(10) Pub. No.: US 2003/0175495 A1
(43) Pub. Date: Sep. 18, 2003

(54) Grip tape for sports implements

(76) Inventor: Herfried Lammer, Lauterach (AT)

Correspondence Address: FINNEGAN, HENDERSON, FARABOW, GARRETT & DUNNER, LLP, 1300 I STREET, NW, WASHINGTON, DC, 20005, US

(21) Appl. No.: 10/343,702

(22) PCT Filed: Jul. 3, 2002
(86) PCT No.: PCT/EP02/07392

(30) Foreign Application Priority Data
Jul. 13, 2001 (DE) 10134168.7

(51) Int. Cl. B32B 17/02; B32B 21/02; B32B 23/02; B32B 27/02

(52) U.S. Cl. 428/310.5; 428/402; 442/320

(57) ABSTRACT

The present invention relates to a grip tape (2) and replacement grip tape for sports implements, like tennis, squash, racketball and badminton rackets, or clubs, as well as to a process for producing the same. The grip tape and replacement grip tape according to the present invention comprise a phase change material for dissipating and/or storing body heat of a player, so that the grip feeling for the player is improved considerably.

### TECHNICAL FIELD OF THE INVENTION

The present invention relates to a grip tape, i.e., a tape or strip to be wrapped around the handle of a sports implement, like a racket or club to be used for ball games, and to a replacement grip tape for such implements (ball game rackets or clubs), in particular tennis, squash, racketball, badminton rackets and golf clubs, as well as to processes for producing the same.

### BACKGROUND OF THE INVENTION

Grip tapes of this kind for sports implements, which are also called “grips” in the art, are wrapped around the grip or handle of a sports implement so that a player can handle the sports implement in the most precise and comfortable manner. In this connection, different criteria such as, for example, tackiness or tack (adhesive force), carrying-off of moisture and cushioning effect are important. A conventional replacement grip tape is, for example, described in U.S. Pat. No. 5,695,418. This replacement grip tape comprises a felt layer, with a closed cell polyurethane layer applied to the one side thereof and an adhesive layer with a liner applied to the other side thereof. The closed cell polyurethane layer is said to improve the shock absorbing and cushioning effect.

The replacement grip tape described in U.S. Pat. No. 5,695,418 with its closed cell polyurethane layer cannot absorb moisture or can only absorb little moisture so that due to the sweat generated by the player the tackiness of the grip tape decreases as the duration of the handling of the sports implement during a match increases. Thus, the handling of the sports implement is worsened considerably. Moreover, U.S. Pat. No. 5,695,418 describes only replacement grip tapes.

Latent heat storing materials are also known in the prior art. For example DE-A-198 13 562 describes a latent heat body wherein a paraffin-based latent heat storing material is received in a support material having receiving spaces. The support material consists of individual support material elements which are, e.g., bonded together, wherein capillary receiving spaces for the latent heat storing material are formed at least between the support material elements. A further example for a latent heat storing material and the possible use thereof in low temperature protection suits, ski boot liners, thermal socks, gloves and face masks is mentioned in U.S. Pat. No. 5,722,482. Moreover, it is referred to WO-A-00/70983 which describes the use of latent heat storing materials in shoes.

### SUMMARY OF THE INVENTION

It is an object of the present invention to provide an improved grip tape and replacement grip tape having in particular an improved tackiness and a better cushioning effect vis-à-vis known grip tapes. This object is achieved with the features of the claims.

In achieving this object, the invention starts out from the basic idea that for improving the tackiness, the moisture usually caused by sweat between the hand of the player and the grip tape should be avoided to a large extent. For this purpose, the grip tape according to the present invention comprises a latent heat storing material which dissipates body heat of the player and/or controls the temperature of the grip tape and/or the hand of the player during a match. In accordance with a preferred embodiment of the grip tape of the present invention, the outer layer of the grip tape, which is in contact with the hand of the player, is made of an open cell polyurethane material which is able to absorb and/or carry off moisture.

The latent heat storing materials being used in the present invention are often also called phase change materials (PCM). Examples for phase change materials of the kind useful in the present invention are described in U.S. Pat. No. 5,851,338, U.S. Pat. No. 5,955,188, U.S. Pat. No. 6,077,597 and U.S. Pat. No. 6,099,894. The phase change material used in accordance with the present invention preferably consists of fibers, fabrics or foams containing microspheres or microcapsules filled with the actual phase change material. The phase change material is selected such that the phase change from solid to liquid and vice versa, wherein heat is absorbed during liquefaction and released during solidification, takes place in a temperature range close to the body temperature of the player, e.g. at 34 to 36° C., preferably at about 35° C. Any suitable combination of phase change materials can also be used.

By means of the grip tape and replacement grip tape according to the present invention, the tackiness (adhesive force) of the grip can be improved permanently because due to the use of the phase change material the temperature of the grip tape is controlled such that the player's hand sweats less. Thus, the grip feeling and/or the tack remain more constant as compared with conventional grip tapes.

Moreover, it surprisingly turned out to be favorable that by the use of the phase change material also the cushioning effect is influenced advantageously. Thus, by the use of the grip tape and replacement grip tape according to the present invention the handling of sports implements can be improved considerably.

### BRIEF DESCRIPTION OF THE DRAWINGS

FIG. 1 is a cross-sectional view of a first embodiment of a grip tape according to the present invention;

FIG. 2 is a cross-sectional view of a second embodiment of a grip tape according to the present invention;

FIG. 3 is a cross-sectional view of a first embodiment of a replacement grip tape according to the present invention;

FIG. 4 is a cross-sectional view of a second embodiment of a replacement grip tape according to the present invention; and

FIG. 5 is a diagram comparing the equilibrium temperatures of conventional grip tapes and grip tapes according to the present invention.

### DETAILED DESCRIPTION OF THE PREFERRED EMBODIMENTS

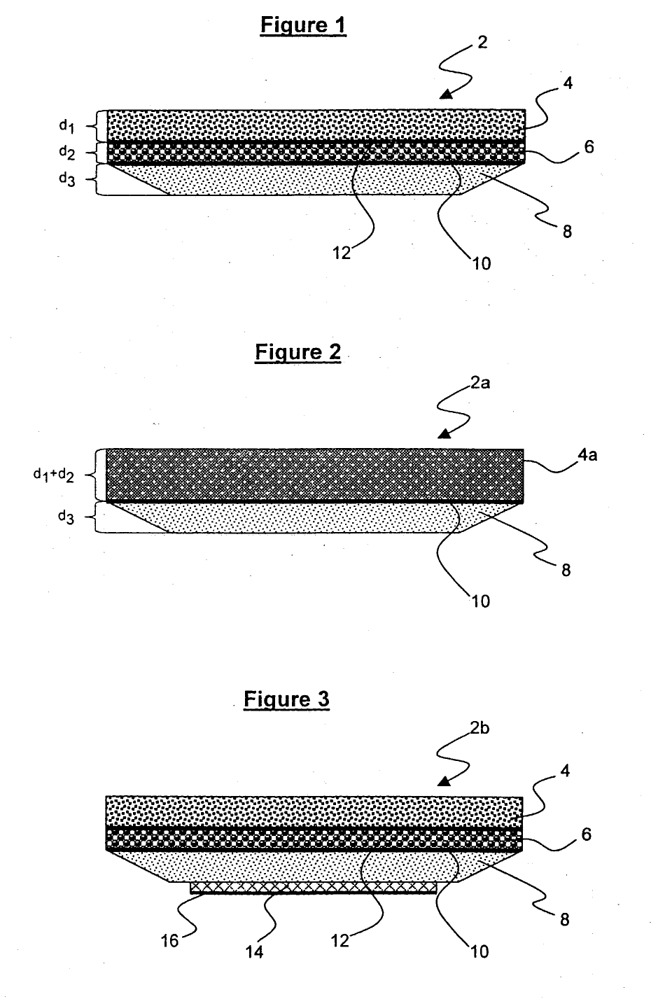

FIG. 1 is a cross-sectional view of a grip tape 2 according to the present invention. The grip tape 2 is suitable for any kind of sports implement like ball game rackets, e.g. tennis, squash, racketball or badminton rackets, or clubs, and has an essentially longitudinal shape so that it can be wrapped around the grip or handle of a sports implement. According to the embodiment shown in FIG. 1, the grip tape 2 according to the present invention consists of three layers. This layer structure comprises an outer layer 4, a center layer 6 and an inner layer 8. When the sports implement is in use, the outer layer 4 contacts the hand of the player and should therefore be made of a suitable material which can absorb and/or carry off moisture. Particularly preferable for outer layer 4 is an open cell polyurethane material which has particularly advantageous properties as regards storing and carrying-off of moisture as well as dampening. The thickness d₁ of the outer layer 4 is preferably about 0.10 to 0.50 mm, particularly preferably about 0.15 to 0.25 mm.

The center layer 6 of FIG. 1 comprises at least one phase change material (PCM). Preferably, the center layer 6 consists essentially completely of PCM. Suitable phase change materials which are contained in layer 6 or are used for forming this layer can, for example, be obtained from Outlast Technologies, Inc., Frisby Technologies, Inc. or BASF company. The phase change material is typically used in an amount of about 15 to 200 g/m², preferably about 25 to 80 g/m², and more preferably about 50 to 60 g/m². The preferred phase change material is provided in the form of microspheres being arranged in a binder material in order to form the center layer 6.

The embodiment of the grip tape 2 according to the present invention and as shown in FIG. 1 additionally comprises an inner layer 8 that is preferably made of felt and serves as a base or support layer. The inner layer 8 has preferably a trapezoidal cross-section so that wrapping the grip tape around the grip of a sports implement is facilitated. The center layer 6 and the inner layer 8 together have a thickness d₂+d₃ of preferably about 1.05 to 1.85 mm. Thus, the grip tape 2 has an overall thickness of preferably about 1.3 to 2.3 mm, more preferably about 1.3 to 2.0 mm. The inner layer 8, which serves as the base layer, can directly be connected with the center layer 6, e.g. by laminating, or can include a separate connecting layer 10, e.g. in the form of an adhesive layer. The same holds true for the connection between the outer layer 4 and the center layer 6, in which a connecting layer 12 can also be provided.

FIG. 2 shows another preferred embodiment of a grip tape 2a according to the present invention. The structure of the grip tape 2a of FIG. 2 essentially corresponds to that of the grip tape 2 described with reference to FIG. 1; however, the grip tape 2a comprises an outer layer 4a, which is essentially a combination of layers 4 and 6 of FIG. 1, in other words, in the grip tape 2a the phase change material is integrated in the outer layer 4a. The layer 4a is preferably made of an open cell polyurethane material into which the phase change material is included. The amount of phase change material in the layer 4a preferably ranges between 15 and 200 g/m², more preferably between 25 to 80 g/m² and most preferably between 50 and 60 g/m². An optimum of the mass amount of phase change material in the layer 4a lies preferably in the range of about 5 to 20%, more preferably 10 to 15%. The grip tape 2a also has an inner layer 8 serving as the base or support layer and being made preferably of felt, on which the outer layer 4a is provided.

The embodiment of the grip tape 2a according to the present invention, as shown in FIG. 2, is configured of two main layers only, so that it can be produced more easily and at the same time the phase change material is arranged more closely to the player so that the desired cooling effect is achieved more quickly. Moreover, it surprisingly turned out that the cushioning effect in the grip tape 2a is particularly favorable as compared with conventional grip tapes.

The grip tape 2a according to FIG. 2 has an overall thickness of preferably about 1.3 to 2.3 mm, particularly preferably about 1.3 to 2.0 mm, wherein the outer layer 4 is about 0.10 to 0.80 mm thick, preferably about 0.15 to 0.50 mm, and the inner layer 8 is about 0.50 to 1.50 mm thick, preferably about 0.75 to 1.25 mm. In the embodiment according to FIG. 2 the outer layer 4a can be directly applied to the inner layer 8, or alternatively a connecting layer 10 can be present.

FIG. 3 shows an embodiment of a replacement grip tape 2b according to the present invention. The basic structure of the replacement grip tape 2b of FIG. 3 essentially corresponds to that of the grip tape 2 described with reference to FIG. 1. However, the replacement grip tape 2b additionally comprises an adhesive strip 14 extending essentially along the length of the grip tape. The adhesive strip 14 is provided on the inner surface of the layer 8, i.e. on the surface of the layer 8 facing away from the layers 4 and 6. Moreover, the adhesive strip 14 is preferably provided with a liner 16 which covers the exposed adhesive surface of the adhesive strip 14. For applying the replacement grip tape 2b to a grip of a sports implement, the liner 16 must first be removed in order to expose the adhesive surface of the adhesive strip 14, so that subsequently the replacement grip tape 2b can be wrapped about the grip of the sports implement.

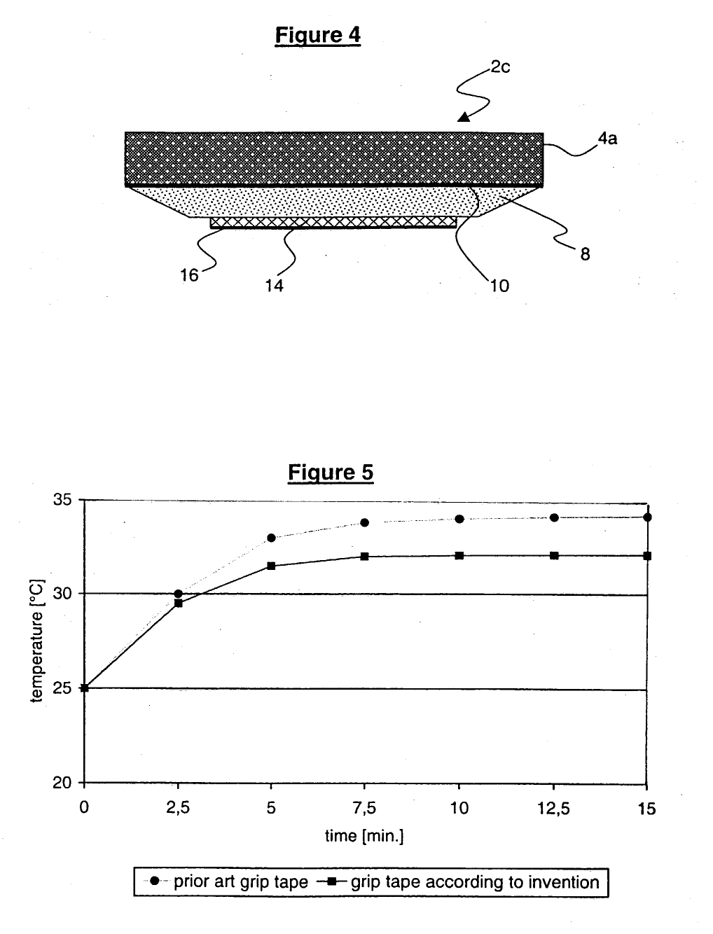

FIG. 4 shows a further embodiment of a replacement grip tape 2c according to the present invention. The structure of this replacement grip tape 2c essentially corresponds to the structure of the grip tape 2a described with reference to FIG. 2. Additionally, in this grip tape 2c an adhesive strip 14, which is preferably provided with a liner 16, is present on the surface of the layer 8 facing away from the phase change material.

The diagram of FIG. 5 shows the equilibrium temperature which is provided between the hand of a player and a grip tape, depending on time, for a conventional grip tape and a grip tape or replacement grip tape according to the present invention. The structure of the conventional grip tape used for the comparison of FIG. 5 is that of the grip tape according to the present invention without a phase change material. The structure of the grip tape according to the present invention which was used for the measurement corresponds to that of the grip tape 2a shown in FIG. 2, in which the phase change material is integrated in the outer layer 4a. The mass amount of phase change material in the grip tape 2a used for this measurement example is 10%, and the outer layer 4a is made of open cell polyurethane material. This mass amount corresponds to about 55 g/m². As can be taken from the diagram of FIG. 5, already after about 5 minutes an equilibrium temperature is found for both the conventional grip tape and also for the grip tape according to the present invention. While in the conventional grip tape, however, the equilibrium temperature is about 34° C., in the grip tape according to the present invention, which comprises about 10% phase change material, the equilibrium temperature is about 32° C. Thus, due to the use of the phase change material, the equilibrium temperature of the grip tape according to the present invention is about 2° C. lower than that of a conventional grip tape. Consequently, the hand of the player sweats less with the grip tape according to the present invention, so that less liquid has to be absorbed by the grip tape. This leads to an improved grip feeling because the characteristic of the grip tape (e.g., tack, cushioning effect) is constant or is at least retained over a longer period of time. Moreover, it turned out that the addition of the phase change material does not change the liquid carrying-off and/or the liquid storing capacity. It is a further surprising effect that due to the use of the phase change material the cushioning effect is influenced in a particularly favorable manner which leads to an additional improvement of the grip feeling.

For producing the grip tape according to the present invention, the heat change material can, as already discussed above, be integrated in the outer layer 4a consisting preferably of open cell polyurethane material or foam (according to the embodiments of FIGS. 2 and 4) or be applied to the inner layer 8 as a separate layer 6 (according to the embodiments of FIGS. 1 and 3). Alternatively or additionally, a separate phase change material layer can also be applied to the outside of the outer layer 4. However, the application to the inner layer 8 is preferred because this offers the additional possibility to needle punch the inner layer 8, which is preferably made of felt, so that it has improved moisture absorption properties.

Furthermore, the surface of the grip tape can be provided with a pattern, for example in the form of a stroke or symbol, for example by embossing. Moreover, openings or holes can be formed in the grip tape in order to improve moisture absorption and/or ventilation.

Under the inner layer 8 at least a further layer may be formed, said further layer having, for example, a different color, shock-absorbing effect and/or a particularly good cushioning effect. Felt, non-woven or elastomeric materials can, e.g., be used for this/these additional layer(s). Even with the additional layer(s), the overall thickness of such grip tapes according to the present invention should range preferably between 1.3 and 2.3 mm, particularly preferably 1.3 and 2.0 mm.

1. A grip tape (2; 2a) for sports implements, said grip tape comprising a phase change material for dissipating and/or storing body heat of a player.

2. The grip tape (2; 2a) according to claim 1 comprising a layer structure including at least two stacked layers (4, 6, 8; 4a, 8).

3. The grip tape (2a) according to claim 1 or 2 comprising an inner layer (8) and an outer layer (4a), wherein the inner layer (8) is made of felt and the outer layer (4) comprises an open cell polyurethane material in which the phase change material is provided.

4. The grip tape (2) according to claim 1 or 2 comprising an inner layer (8), a center layer (6) and an outer layer (4), wherein the inner layer (8) is made of felt, the center layer (6) comprises a phase change material and the outer layer (4) an open cell polyurethane material.

5. The grip tape (2; 2a) according to any one of claims 1 to 4, wherein the phase change material is provided in an amount of about 15 to 200 g/m², preferably about 25 to 80 g/m² and particularly preferably about 50 to 60 g/m².

6. The grip tape (2; 2a) according to any one of claims 1 to 5 having a thickness of about 1.3 to 2.3 mm.

7. The grip tape (2a) according to any one of claims 3, 5 and 6, wherein the outer layer (4a) has a thickness (d₁+d₂) of about 0.10 to 0.80 mm, preferably about 0.15 to 0.50 mm, and the inner layer (8) has a thickness (d₃) of about 0.50 to 1.50 mm, preferably about 0.75 to 1.25 mm.

8. The grip tape according to any one of claims 4 to 6, wherein the outer layer (4) has a thickness (d₁) of about 0.10 to 0.50 mm, preferably about 0.15 to 0.25 mm and the inner and center layers (8, 6) together have a thickness (d₂+d₃) of about 1.05 to 1.85 mm.

9. The grip tape (2; 2a) according to any one of claims 1 to 8, wherein the phase change material is provided within microspheres.

10. The grip tape (2; 2a) according to any one of claims 1 to 9, wherein a plurality of different phase change materials is provided.

11. The grip tape (2; 2a) according to any one of claims 1 to 10, wherein the phase change material is adapted such that the temperature range of the phase change is between about 32° C. and 38° C., preferably between about 34° C. and 36° C., and particularly preferably to a temperature of about 35° C.

12. A replacement grip tape (2b; 2c) for sports implements, said replacement grip tape comprising a layer structure (4, 4a, 6, 8, 14, 16) consisting of at least two layers, wherein one layer (14) is an adhesive layer and at least one further layer (4, 4a, 6, 8) comprises a phase change material for dissipating and/or storing body heat of a player.

13. The replacement grip tape (2c) according to claim 12 comprising a layer (8) made of felt and arranged on the adhesive layer (14), and an outer layer (4a) comprising an open cell polyurethane material in which the phase change material is provided.

14. The replacement grip tape (2b) according to claim 12 comprising a layer (8) made of felt and arranged on the adhesive layer (14), a layer (6) comprising the phase change material and being arranged on the felt layer (8), and an outer layer (4) comprising an open cell polyurethane material.

15. The replacement grip tape (2b; 2c) according to any one of claims 12 to 14, wherein the phase change material is provided in an amount of about 15 to 200 g/m², preferably about 25 to 80 g/m² and particularly preferably about 50 to 60 g/m².

16. The replacement grip tape (2b; 2c) according to any one of claims 12 to 15 having a thickness of about 1.3 to 2.5 mm.

17. The replacement grip tape (2c) according to any one of claims 13, 15 and 16, wherein the outer layer (4a) has a thickness (d₁+d₂) of about 0.10 to 0.80 mm, preferably about 0.15 to 0.50 mm, and the felt layer (8) has a thickness (d3) of about 0.50 to 1.50 mm, preferably of about 0.75 to 1.25 mm.

18. The replacement grip tape (2b) according to any one of claims 14 to 16, wherein the outer layer (4) has a thickness (d₁) of about 0.10 to 0.50 mm, preferably 0.15 to 0.25 mm and the felt layer (8) and the layer (4) comprising the phase change material together have a thickness (d₂+d₃) of about 1.05 to 1.85 mm.

19. The replacement grip tape (2b; 2c) according to any one of claims 12 to 18, wherein the phase change material is provided within microspheres.

20. The replacement grip tape (2b; 2c) according to any one of claims 12 to 19, wherein a plurality of different phase change materials is provided.

21. The replacement grip tape (2b; 2c) according to any one of claims 12 to 20, wherein the phase change material is adapted such that the temperature range of the phase change is between about 32° C. and 38° C., preferably between about 34° C. and 36° C., and particularly preferably to a temperature of about 35° C.

22. A process for producing a grip tape (2; 2a) for sports implements, said process comprising the steps of:
(a) providing a base layer (8); and
(b) applying a phase change material to the base layer (8).

23. The process according to claim 22, wherein the phase change material is integrated in a cover layer (4a) or is applied as a layer (6) under a separate cover layer (4).

24. The process according to claim 22 or 23, wherein the base layer (8) is made of felt.

25. The process according to claim 23 or 24, wherein the layer (4a) containing the phase change material or the layer (4) covering the same comprises an open cell polyurethane material.

26. The process according to any one of claims 22 to 25, wherein the base layer (8) being coated with the phase change material is needle punched.

27. A process for producing a replacement grip tape (2b; 2c) for sports implements, said process comprising the steps of:
(a) providing a base layer (8);
(b) applying an adhesive layer (14) to one surface of the base layer (8); and
(c) applying a phase change material to the other surface of the base layer (8).

28. The process according to claim 27, wherein the phase change material is integrated in a cover layer (4a) or is provided as a layer (6) under a separate cover layer (4).

29. The process according to claim 27 or 28, wherein the base layer (8) is made of felt.

30. The process according to claim 28 or 29, wherein the layer (4a) containing the phase change material or the layer (4) covering the same comprises an open cell polyurethane material.

31. The process according to any one of claims 27 to 30, wherein the base layer (8) being coated with the phase change material is needle punched.

32. Use of the grip tape (2; 2a) according to any one of claims 1 to 11 and of the replacement grip tape (2b; 2c) according to any one of claims 12 to 21 for wrapping around the handle of a tennis racket, squash racket, racketball racket, badminton racket or golf club.
